(19) United States
(12) Patent Application Publication
(10) Pub. No.: US 2021/0001457 A1
(43) Pub. Date: Jan. 7, 2021

(54) CUTTING PLATFORM AND CUTTING EQUIPMENT

(71) Applicants: MIANYANG BOE OPTOELECTRONICS TECHNOLOGY CO., Ltd., Mianyang (CN); BOE TECHNOLOGY GROUP CO., LTD., Beijing (CN)

(72) Inventors: Liangchao WANG, Beijing (CN); Wen WU, Beijing (CN); Jian ZHOU, Beijing (CN); Zengchao GONG, Beijing (CN); Yang WANG, Beijing (CN); Yang XIA, Beijing (CN)

(21) Appl. No.: 16/908,823

(22) Filed: Jun. 23, 2020

(30) Foreign Application Priority Data
Jul. 3, 2019 (CN) 201910594511.3

(51) Int. Cl. B25B 11/00

(52) U.S. Cl. CPC B25B 11/005

(57) ABSTRACT

The present application relates to the field of cutting technology, specifically, to a cutting platform and cutting equipment. The cutting platform may include a first bonding surface, a second bonding surface, and a cutting groove. The second bonding surface is opposite to the first bonding surface, and is used for bonding with a piece to be cut. The cutting groove penetrates the first bonding surface and the second bonding surface, and corresponds to the cutting path of a cutting device, and the cutting groove includes a first groove wall surface and second groove wall surface opposite to each other. A distance between the first groove wall surface and the second groove wall surface increases in a direction from the second bonding surface to the first bonding surface. The solution of the present application can improve product quality and equipment production efficiency.

### CROSS-REFERENCE TO RELATED APPLICATION

This application is based upon and claims priority to Chinese Patent Application No. 201910594511.3, filed on Jul. 3, 2019, where the entire contents thereof are incorporated herein by reference.

### TECHNICAL FIELD

The present application relates to the field of cutting technology and, more specifically, to a cutting platform and a cutting equipment.

### BACKGROUND

At present, laser cutting technology is usually used to cut display panels into a required size and shape. However, during the cutting process, the residual debris generated by the cutting cannot be discharged, and it will stick to the surface of the piece to be cut and the surface of the cutting platform, which seriously affects product quality and equipment production efficiency.

It should be noted that the information disclosed in the above background section is only used to enhance the understanding of the background of the present application and therefore, may include information that does not constitute prior art known to those of ordinary skill in the art.

### SUMMARY

The purpose of this application is to provide a cutting platform and a cutting equipment that can improve product quality and equipment production efficiency.

The first aspect of the present application provides a cutting platform, which includes:

a first bonding surface;

a second bonding surface that is opposite to the first bonding surface and is used for bonding with a piece to be cut;

a cutting groove that penetrates the first bonding surface and the second bonding surface and corresponds to a cutting path of a cutting device, and comprises a first groove wall surface and a second groove wall surface opposite to each other;

wherein a distance between the first groove wall surface and the second groove wall surface increases in a direction from the second bonding surface to the first bonding surface.

In an exemplary embodiment of the present application, it further includes:

a vacuum hole that penetrates the first bonding surface and the second bonding surface, and is provided on at least one side of the cutting groove.

In an exemplary embodiment of the present application, the diameter of the vacuum hole does not change in a direction from the second bonding surface to the first bonding surface, and a minimum distance on the second bonding surface between the vacuum hole and the cutting groove is less than or equal to 10 mm.

In an exemplary embodiment of the present application, at least one of the first groove wall surface and the second groove wall surface is an inclined plane, and the inclined plane is inclined in a direction close to the first bonding surface.

In an exemplary embodiment of the present application, the first bonding surface is a horizontal bonding surface, and an angle between the inclined plane and the first bonding surface is 30° to 85°.

In an exemplary embodiment of the present application, at least one of the first groove wall surface and the second groove wall surface is a serrated surface.

In an exemplary embodiment of the present application, at least one of the first groove wall surface and the second groove wall surface is a first profiled surface, the first profiled surface comprises a first vertical plane and an arc surface connected with each other, and the first vertical plane is connected to the second bonding surface, and the arc surface is connected to the first bonding surface;

wherein, in the vertical direction, a size of the first vertical plane is smaller than a size of the arc surface, and the arc surface protrudes in a direction close to the second bonding surface.

In an exemplary embodiment of the present application, at least one of the first groove wall surface and the second groove wall surface is a second profiled surface, and the second profiled surface comprises a second vertical plane, a connecting horizontal plane and a third vertical plane which are connected in sequence, the second vertical plane is connected to the second bonding surface, and the third vertical plane is connected to the first bonding surface;

wherein, in the vertical direction, a size of the second vertical plane is smaller than a size of the third vertical plane.

In an exemplary embodiment of the present application, a minimum distance between the first groove wall surface and the second groove wall surface is less than or equal to 10 mm.

A second aspect of the present application provides a cutting device, including:

a machine table;

the cutting platform according to any one of the above, wherein the first bonding surface is bonded to the machine table, and the second bonding surface is used to bond to the piece to be cut;

a cutting device which is located on a side of the second bonding surface away from the first bonding surface, and can cut the piece to be cut along the cutting groove, and the debris generated by cutting can pass through the cutting groove and fall into the machine table.

It should be understood that the above general description and the following detailed description are only exemplary and explanatory, and cannot limit the present application.

### BRIEF DESCRIPTION OF THE DRAWINGS

The drawings herein are incorporated into and constitute a part of the specification, show embodiments consistent with the present application, and are used together with the specification to explain the principles of the present application. Understandably, the drawings in the following description are only some embodiments of the present application. For those of ordinary skill in the art, without paying any creative labor, other drawings can be obtained based on these drawings.

FIG. 1 shows a schematic structural diagram of a cutting platform according to an embodiment of the present application;

FIGS. 2 to 9 respectively show schematic cross-sectional views of the cutting platform according to different embodiments of the present application in an A-A direction;

and

FIG. 10 shows a schematic diagram of the positional relationship between the cutting device and the piece to be cut according to an embodiment of the present application.

### DETAILED DESCRIPTION

Example embodiments will now be described more fully with reference to the drawings. However, the example embodiments can be implemented in various forms and should not be construed as being limited to the embodiments set forth herein. On the contrary, providing these embodiments makes the application comprehensive and complete, and fully conveys the concept of the example embodiments for those skilled in the art. The same reference numerals in the drawings denote the same or similar structures, and thus their detailed description will be omitted.

Although relative terms are used in this specification, such as “upper” and “lower” to describe the relative relationship between one component of an icon and another component, these terms are used in this specification only for convenience, for example, the direction of the example described according to the drawings. It can be understood that if the icon device is turned upside down, the “upper” component will become the “lower” component. When a structure is “on” another structure, it may mean that the structure is integrally formed on another structure, or that the structure is “directly” arranged on another structure, or that the structure is “indirectly” arranged on another structure through a third structure.

The terms “a”, “a”, “the”, “said”, etc. are used to indicate the presence of one or more elements/components/etc. The terms “including” and “having” are used to indicate open-ended inclusions and means that there can be other elements/components/etc. in addition to the listed elements/components/etc. The terms “first”, “second”, etc. are only used as markers, and do not limit the number of objects.

When a display panel is cut, in order to avoid that the residual debris generated by the cutting cannot be eliminated, a cutting groove corresponding to a cutting path of a cutting device may be opened on a cutting platform, and the cutting groove is usually a vertical groove. When a flexible display panel is cut, it's not ideal for a width of the cutting groove to be too large, so as to avoid sagging under the influence of gravity; however, if the width of the cutting groove is too narrow, the cutting debris will accumulate and stick to a groove wall of the cutting groove. The cutting jig needs to be cleaned regularly for the corresponding production, but this greatly affects the production efficiency. At the same time, clogging of the cutting groove will also cause poor cutting of the product.

In order to solve the aforementioned technical problems, as shown in FIGS. 1 and 10, an implementation of the present application provides a cutting platform 1 for supporting a piece 3 to be cut. The piece 3 to be cut may be a flexible display panel, but it is not limited to this, and the piece 3 may also be a rigid display panel or other parts to be cut.

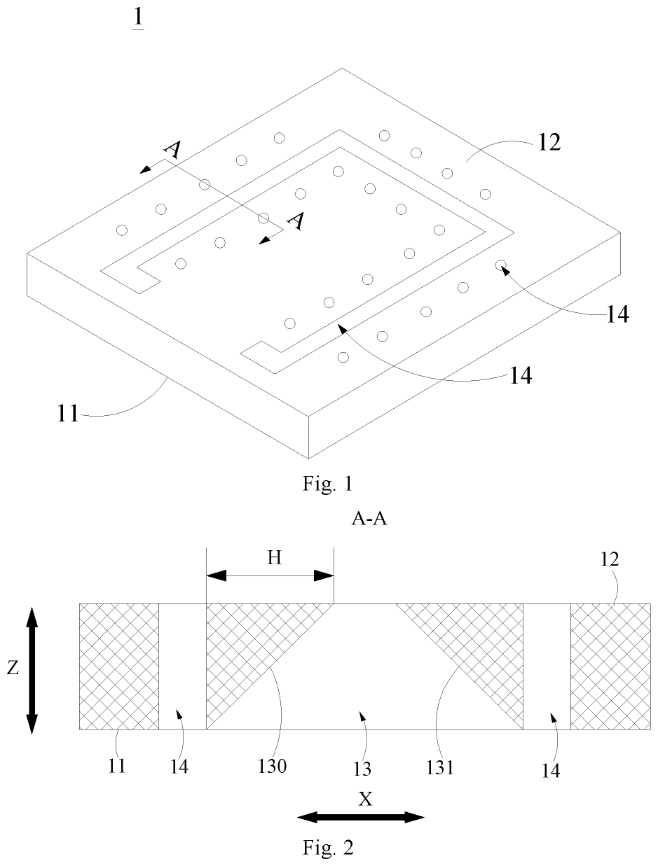

As shown in FIGS. 2-9, the cutting platform 1 may include a first bonding surface 11, a second bonding surface 12, and a cutting groove 13.

The second bonding surface 12 may be opposite to the first bonding surface 11. The second bonding surface 12 is used for bonding with the piece 3 to be cut. Also, the first bonding surface 11 is used for bonding with the machine table 2 of the cutting device, that is to say, the cutting platform 1 may be installed on the machine table 2 and used to support the piece 3 to be cut. Since a surface of the machine table 2 that is bonded to the first bonding surface 11 and a surface of the piece 3 to be cut that is bonded to the second bonding surface 12 are generally flat, in order to ensure the support stability of the cutting platform 1 to the machine table 2 and the piece 3 to be cut, the first bonding surface 11 and the second bonding surface 12 may be flat so as to increase the bonding area of the cutting platform 1 and the machine table 2 as well as the piece 3 to be cut. For example, the first bonding surface 11 and the second bonding surface 12 may extend in the horizontal direction X, that is to say, the first bonding surface 11 and the second bonding surface 12 may both be horizontal bonding surfaces. It should be understood that when the first bonding surface 11 and the second bonding surface 12 are horizontal bonding surfaces, the first bonding surface 11 and the second bonding surface 12 are opposed in a vertical direction Z.

The cutting groove 13 can penetrate the first bonding surface 11 and the second bonding surface 12, and the cutting groove 13 can correspond to a cutting path of the cutting device, that is, the cutting device may cut the piece 3 to be cut along the cutting groove 13. In detail, the cutting groove 13 may include a first groove wall surface 130 and a second groove wall surface 131 opposite to each other. A distance between the first groove wall surface 130 and the second groove wall surface 131 increases in a direction from the second bonding surface 12 to the first bonding surface 11 such that, on one hand, a width of the cutting groove 13 near the second bonding surface 12 being too large is avoided, that is, the bonding area of the second bonding surface 12 and the piece 3 to be cut can be ensured which avoids the sag of the piece 3 to be cut under the influence of gravity, which can improve the cutting accuracy. On the other hand, the overall width of the cutting groove 13 being too narrow is avoided, which causes debris accumulation and adhesion to the groove wall of the cutting groove 13. As a result, the above situation can prevent the cutting groove 13 from being clogged to cause poor cutting, which further improves the quality of the cutting piece 3 after cutting and the equipment production efficiency.

Optionally, a minimum distance between the first groove wall surface 130 and the second groove wall surface 131 may be less than or equal to 10 mm, that is, a distance between the first groove wall surface 130 and the second groove wall surface 131 on the second bonding surface 12 may be less than or equal to 10 mm so as to avoid the sag of the piece 3 to be cut at the cutting groove 13 due to its own gravity, thereby improving the cutting accuracy and thus guarantying the quality of the product.

For example, the cutting platform 1 may further include a vacuum hole 14, the vacuum hole 14 may penetrate the first bonding surface 11 and the second bonding surface 12, and the vacuum hole 14 may be disposed on at least one side of the cutting groove 13. In the process of cutting the piece 3 to be cut, a vacuum evacuation device can apply suction force to the piece 3 to be cut through the vacuum hole 14 so that the piece 3 to be cut can be stably adsorbed on the second bonding surface 12 so as to ensure cutting precision and improve product quality.

Optionally, both sides of the cutting groove 13 may be provided with vacuum holes 14, and the number of vacuum holes 14 on each side may be provided in multiples.

The aforementioned vacuum hole 14 may be a straight hole, that is, the diameter of the vacuum hole 14 does not change in a direction from the second bonding surface 12 to the first bonding surface 11 which can facilitate processing and molding. It should be noted that the vacuum hole 14 may be a circular hole, but it is not limited thereto, and the vacuum hole 14 may also be a square hole or an irregular hole.

In addition, in order to avoid the situation where a cutting edge of the piece 3 to be cut is warped after cutting, the vacuum hole 14 may be disposed close to the cutting groove 13. In detail, on the second bonding surface 12, a minimum distance H between the vacuum hole 14 and the cutting groove 13 may be less than or equal to 10 mm.

The shape of the cutting groove 13 will be described in detail below with reference to the drawings.

### Example One

At least one of the first groove wall surface 130 and the second groove wall surface 131 of the cutting groove 13 may be an inclined plane, and the inclined plane may be inclined in a direction close to the first bonding surface 11, which may reduce the difficulty of processing the cutting groove 13.

When the first bonding surface 11 is a horizontal bonding surface, the angle between the inclined plane and the first bonding surface 11 may be 30° to 85°, which not only facilitates the processing of the cutting groove 13, but also can also avoid that a minimum distance between the cutting groove 13 and the vacuum hole 14 is too large, so that the cutting edge of the piece 3 to be cut can be prevented from being warped.

In an alternative embodiment, as shown in FIG. 2, both the first groove wall surface 130 and the second groove wall surface 131 are inclined planes, that is to say, the cutting groove 13 may be a “A” shape.

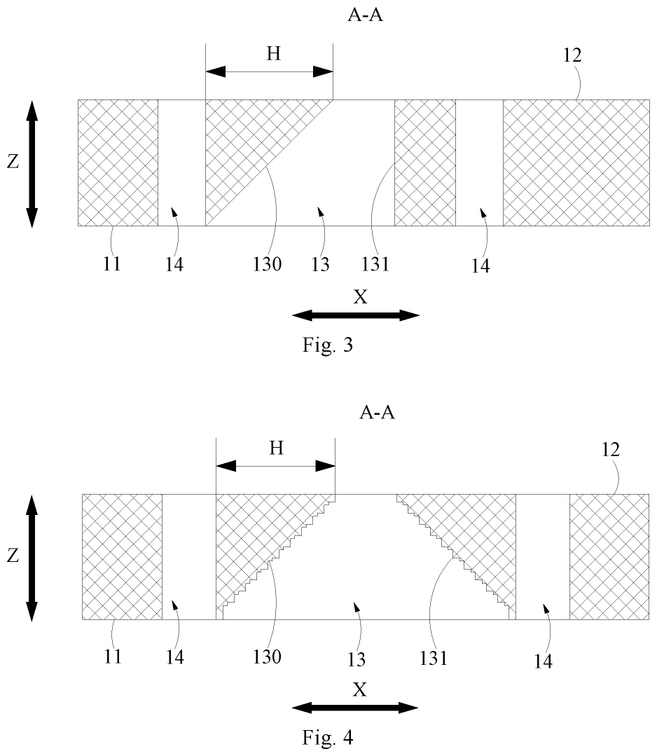

In another alternative embodiment, as shown in FIG. 3, one of the first groove wall surface 130 and the second groove wall surface 131 may be an inclined plane. The other may be a vertical plane (the vertical plane is a plane extending in the vertical direction Z). However, it is not limited to this, and the other can also be a serrated surface, an arc surface, or other irregular surfaces.

It should be noted that the cutting grooves 13 of the two embodiments can be manufactured by wire cutting.

### Example Two

At least one of the first groove wall surface 130 and the second groove wall surface 131 of the cutting groove 13 may be a serrated surface, which can reduce the difficulty of processing the cutting groove 13.

In an alternative embodiment, as shown in FIG. 4, the first groove wall surface 130 and the second groove wall surface 131 are both serrated surfaces.

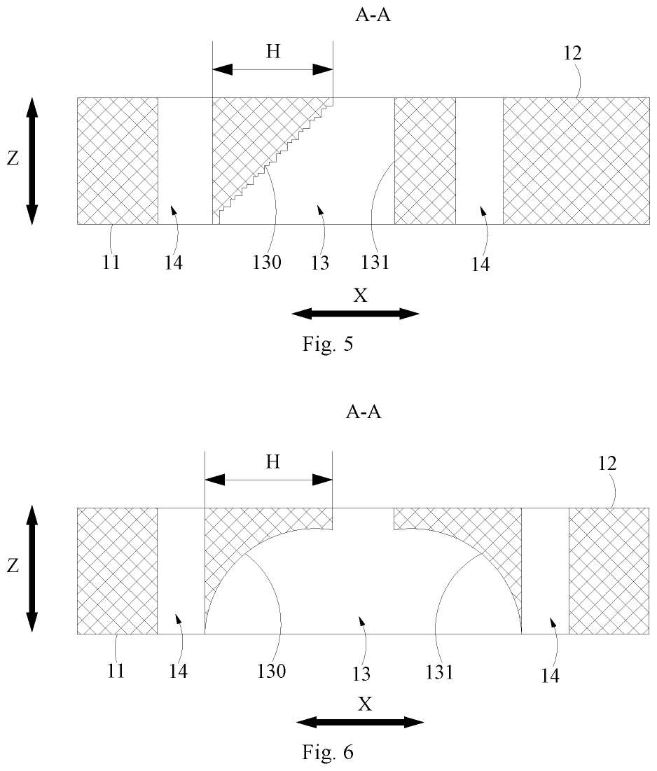

In another alternative embodiment, as shown in FIG. 5, one of the first groove wall surface 130 and the second groove wall surface 131 may be a serrated surface, and the other may be a vertical plane. However, it is not limited to this, and the other may also be an inclined plane, an arc surface, or other irregular surfaces.

It should be noted that the cutting grooves 13 of the two embodiments can be polished by a tapered cutter or a flat-bottom end mill.

### Example Three

At least one of the first groove wall surface 130 and the second groove wall surface 131 of the cutting groove 13 may be a first special profiled surface, the first special-profiled surface may include a first vertical plane and an arc surface connected, and the first vertical plane is connected to the second bonding surface 12, and the arc surface is connected to the first bonding surface 11. Among them, in the vertical direction Z, the size of the first vertical plane is smaller than the size of the arc surface, and the arc surface protrudes in a direction close to the second bonding surface 12 to further prevent the accumulation of debris after cutting and sticking to the groove wall of the cutting groove 13.

In this embodiment, the arc surface and the second bonding surface 12 are connected by the first vertical plane, so that the processing difficulty of the cutting groove 13 can be reduced.

In an alternative embodiment, as shown in FIG. 6, the first groove wall surface 130 and the second groove wall surface 131 are both first profiled surfaces.

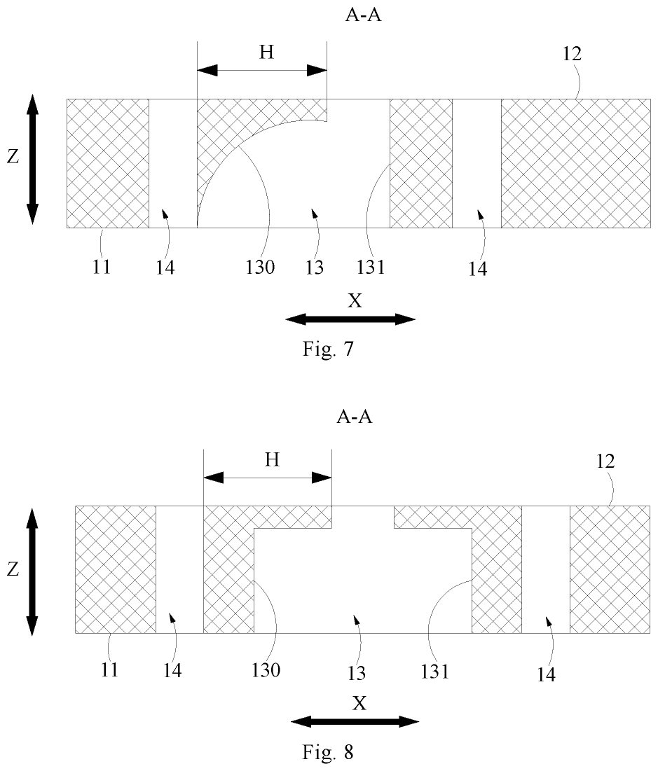

In another alternative embodiment, as shown in FIG. 7, one of the first groove wall surface 130 and the second groove wall surface 131 may be a first profiled surface, and the other may be a vertical plane, but is not limited thereto, the other can also be an inclined plane, a serrated surface or other irregular surfaces.

It should be noted that the cutting grooves 13 of these two embodiments can be polished by a tapered cutter or a flat-bottom end mill.

### Example Four

At least one of the first groove wall surface 130 and the second groove wall surface 131 of the cutting groove 13 may be a second profiled surface to reduce the difficulty of processing the cutting groove 13. In detail, the second profiled surface may include a second vertical plane, a connecting horizontal plane and a third vertical plane connected in sequence, the second vertical plane is connected to the second bonding surface 12, and the third vertical plane is connected to the first bonding surface 11. In the vertical direction Z, a size of the second vertical plane is smaller than a size of the third vertical plane, so as to further prevent the accumulated debris from adhering to the groove wall of the cutting groove 13 after cutting.

In an alternative embodiment, as shown in FIG. 8, the first groove wall surface 130 and the second groove wall surface 131 are both second profiled surfaces.

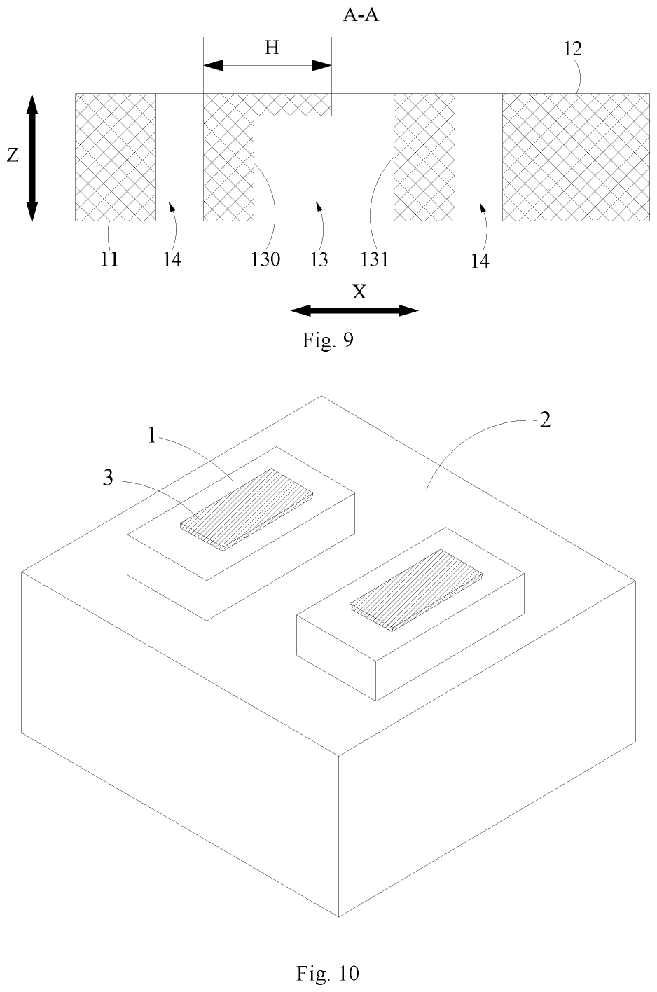

In another alternative embodiment, as shown in FIG. 9, one of the first groove wall surface 130 and the second groove wall surface 131 may be a second profiled surface, and the other may be a vertical plane, but it is not limited thereto, the other can also be an inclined plane, a serrated surface or other irregular surfaces.

It should be noted that the cutting grooves 13 of these two embodiments can be polished by a tapered cutter or a flat-bottom end mill.

It should be understood that the shape of the cutting groove 13 in this application is not limited to the aforementioned four embodiments, but may be other shapes, as long as the distance between the first groove wall surface 130 and the second groove wall surface 131 increases in a direction from the second bonding surface 12 to the first bonding surface 11.

An embodiment of the present application also provides a cutting equipment, as shown in FIG. 10, which includes a machine table 2, a cutting platform 1, and a cutting device (not shown in the figure). This cutting platform 1 is described in any of the foregoing embodiments, and is not described in detail here.

The first bonding surface 11 of the cutting platform 1 can be bonded to the machine table 2, and the second bonding surface 12 is used to bond to the piece 3 to be cut; and the cutting device is located on a side of the second bonding surface 12 away from the first bonding surface 11 and can cut the piece 3 to be cut along the cutting groove 13, and the debris generated by the cutting can fall into the machine table 2 through the cutting groove 13. For example, the cutting device may be a laser cutting device.

In addition, when the cutting platform 1 includes a vacuum hole 14, the cutting equipment may further include a vacuum evacuation device, which may be disposed in the machine table 2 and communicate with the vacuum hole 14.

It should be noted that a plurality of cutting platforms 1 may be provided, and each cutting platform 1 may be arranged on the machine table 2 at intervals.

The technical solution provided by this application can achieve the following beneficial effects:

The cutting platform and the cutting equipment provided by the present application, by setting a cutting groove corresponding to the cutting line emitted by the cutting device on the cutting platform, the debris generated by the cutting can fall into the cutting groove to avoid the debris sticking to the surface of the piece to be cut and the second bonding surface of the cutting platform, which can improve the quality of the piece to be cut after cutting and the production efficiency of the equipment.

In addition, the distance between the first groove wall surface and the second groove wall surface of the cutting groove increases in the direction from the second bonding surface to the first bonding surface, so that on the one hand, it can avoid that the width of the cutting groove near the second bonding surface is too large, that is, the bonding area of the second bonding surface and the piece to be cut can be ensured, which can avoid the sag of the piece to be cut under the influence of gravity, so that the cutting accuracy can be improved. On the other hand, it can avoid that the overall width of the cutting groove is too narrow, which may cause debris accumulation and adhesion to the groove wall of the cutting groove, thereby the above situation can prevent the cutting groove 13 from being clogged to cause poor cutting, so that the quality of the cutting piece 3 after cutting and the equipment production efficiency can be improved.

After considering the description and practicing the invention disclosed herein, those skilled in the art will easily think of other embodiments of the present application. This application is intended to cover any variations, uses, or adaptations of this application, which follow the general principles of this application and include common general knowledge or customary technical means in the technical field not disclosed in this application. The description and examples are to be considered exemplary only, and the true scope and spirit of this application are pointed out by the appended claims.

What is claimed is:

1. A cutting platform, comprising:
a first bonding surface;
a second bonding surface that is opposite to the first bonding surface and is used for bonding with a piece to be cut;
a cutting groove that penetrates the first bonding surface and the second bonding surface and corresponds to a cutting path of a cutting device, and comprises a first groove wall surface and a second groove wall surface opposite to each other;
wherein a distance between the first groove wall surface and the second groove wall surface increases in a direction from the second bonding surface to the first bonding surface.

2. The cutting platform according to claim 1, further comprising a vacuum hole that penetrates the first bonding surface and the second bonding surface that is provided on at least one side of the cutting groove.

3. The cutting platform according to claim 2, wherein the diameter of the vacuum hole does not change in a direction from the second bonding surface to the first bonding surface, and a minimum distance on the second bonding surface between the vacuum hole and the cutting groove is less than or equal to 10 mm.

4. The cutting platform according to claim 1, wherein at least one of the first groove wall surface and the second groove wall surface is an inclined plane, and the inclined plane is inclined in a direction close to the first bonding surface.

5. The cutting platform according to claim 4, wherein the first bonding surface is a horizontal bonding surface, and an angle between the inclined plane and the first bonding surface is 30° to 85°.

6. The cutting platform of claim 1, wherein at least one of the first groove wall surface and the second groove wall surface is a serrated surface.

7. The cutting platform according to claim 1, wherein:
at least one of the first groove wall surface and the second groove wall surface is a first profiled surface, the first profiled surface comprises a first vertical plane and an arc surface connected with each other, and the first vertical plane is connected to the second bonding surface, and the arc surface is connected to the first bonding surface; and
in the vertical direction, a size of the first vertical plane is smaller than a size of the arc surface, and the arc surface protrudes in a direction close to the second bonding surface.

8. The cutting platform according to claim 1, wherein:
at least one of the first groove wall surface and the second groove wall surface is a second profiled surface, and the second profiled surface comprises a second vertical plane, a connecting horizontal plane and a third vertical plane which are connected in sequence, the second vertical plane is connected to the second bonding surface, and the third vertical plane is connected to the first bonding surface; and
in the vertical direction, a size of the second vertical plane is smaller than a size of the third vertical plane.

9. The cutting platform according to claim 1, wherein a minimum distance between the first groove wall surface and the second groove wall surface is less than or equal to 10 mm.

10. A cutting equipment, comprising:
a machine table;
a cutting platform comprising:
a first bonding surface;
a second bonding surface that is opposite to the first bonding surface and is used for bonding with a piece to be cut;
a cutting groove that penetrates the first bonding surface and the second bonding surface and corresponds to a cutting path of a cutting device, and comprises a first groove wall surface and a second groove wall surface opposite to each other;
wherein a distance between the first groove wall surface and the second groove wall surface increases in a direction from the second bonding surface to the first bonding surface;
wherein the first bonding surface is bonded to the machine table, and the second bonding surface is used to bond to the piece to be cut; and
a cutting device located on a side of the second bonding surface away from the first bonding surface, and configured to cut the piece to be cut along the cutting groove, such that the debris generated through cutting passes through the cutting groove and falls into the machine table.
